(19) United States
(12) Patent Application Publication
(10) Pub. No.: US 2025/0009149 A1
(43) Pub. Date: Jan. 9, 2025

(54) WALL HANGERS AND ASSEMBLIES FOR HEAVYWEIGHT OBJECTS

(71) Applicant: 3M INNOVATIVE PROPERTIES COMPANY, Saint Paul, MN (US)

(72) Inventors: Joseph A. Hoffman, Minneapolis, MN (US); Andrew T. Helgeson, Oakdale, MN (US)

(21) Appl. No.: 18/710,544

(22) PCT Filed: Nov. 15, 2022
(86) PCT No.: PCT/IB2022/061005

§ 371 Date: May 15, 2024

Related U.S. Application Data
(60) Provisional application No. 63/279,809, filed on Nov. 16, 2021.

(51) Int. Cl. A47G 1/20

(52) U.S. Cl. CPC A47G 1/20

(57) ABSTRACT

Wall hangers and assemblies of the present disclosure include two pivotally connected plates, one or more curved prongs on each plate, and a load bearing hook. The prongs are typically integral with a side edge of the plate and are typically curved in a downwards direction towards the bottom edge of the plate.

### BACKGROUND

Numerous products and devices exist for installing a hook or hanging device in a wall, such as for hanging a picture frame, a mirror, or the like. Conventional nails and screws are not always convenient solutions and may not provide sufficient support strength in the wall, particularly in the case of drywall, or other friable wallboards, which are relatively weak. Other hanging devices may avoid the use and attendant drawbacks of conventional fasteners, but nonetheless may result in excessive damage to the wallboard, require the use of conventional tools, or fail to consistently hold the desired weight.

### SUMMARY

The present inventors have devised a wall hanger construction and wall hanger assemblies that provide stronger support in load bearing directions than currently available solutions. The wall hangers and hanger assemblies may be installed without the use of tools and may be used to mount heavy weight objects like picture frames without damaging the wall or losing material fidelity. The hangers feature a base plate and one or more prongs that include a relatively high ratio of height to thickness, which can provide both an improved installation experience and more routinely successful mounting. The hangers may be combined with other components that allow for temporary attachment of a hanger assembly to the wall, letting a user iteratively select the best location for both the hanger and the object to be mounted without fully committing to the installation.

In one aspect, the present disclosure provides a wall hanger assembly comprising: a base plate, including a proximal edge, a distal edge, and opposing side edges, the base plate further including a curved prong having a base, wherein the prong extends outwardly along an arc to a wall-penetrating outer end, and wherein the base of the prong is coincident with one of the opposing side edges. Such wall hanger assemblies may further comprise an insert plate pivotally coupled to the base plate and including a proximal edge, a distal edge, and opposing side edges. The insert plate can further include a second curved prong having a base, wherein the prong extends outwardly along an arc to a wall-penetrating outer end, and wherein the base of the prong is coincident with one of the opposing side edges of the insert plate. The insert plate and base plate may be coupled to create a hinge axis that is spaced a certain height from the front face of the first insert plate.

As used herein “geometry” refers to the size and shape of an element.

The words “preferred” and “preferably” refer to embodiments of the disclosure that may afford certain benefits, under certain circumstances. However, other embodiments may also be preferred, under the same or other circumstances. Furthermore, the recitation of one or more preferred embodiments does not imply that other embodiments are not useful, and is not intended to exclude other embodiments from the scope of the disclosure.

In this application, terms such as “a”, “an”, and “the” are not intended to refer to only a singular entity, but include the general class of which a specific example may be used for illustration. The terms “a”, “an”, and “the” are used interchangeably with the term “at least one.” The phrases “at least one of” and “comprises at least one of” followed by a list refers to any one of the items in the list and any combination of two or more items in the list.

As used herein, the term “or” is generally employed in its usual sense including “and/or” unless the content clearly dictates otherwise.

The term “and/or” means one or all of the listed elements or a combination of any two or more of the listed elements.

Also herein, all numbers are assumed to be modified by the term “about” and preferably by the term “exactly.” As used herein in connection with a measured quantity, the term “about” refers to that variation in the measured quantity as would be expected by the skilled artisan making the measurement and exercising a level of care commensurate with the objective of the measurement and the precision of the measuring equipment used.

Also herein, the recitations of numerical ranges by endpoints include all numbers subsumed within that range as well as the endpoints (e.g., 1 to 5 includes 1, 1.5, 2, 2.75, 3, 3.80, 4, 5, etc.).

As used herein as a modifier to a property or attribute, the term “generally”, unless otherwise specifically defined, means that the property or attribute would be readily recognizable by a person of ordinary skill but without requiring absolute precision or a perfect match (e.g., within +/−20% for quantifiable properties). The term “substantially”, unless otherwise specifically defined, means to a high degree of approximation (e.g., within +/−10% for quantifiable properties) but again without requiring absolute precision or a perfect match. Terms such as same, equal, uniform, constant, strictly, and the like, are understood to be within the usual tolerances or measuring error applicable to the particular circumstance rather than requiring absolute precision or a perfect match.

The above summary of the present disclosure is not intended to describe each disclosed embodiment or every implementation of the present disclosure. The description that follows more particularly exemplifies illustrative embodiments. In several places throughout the application, guidance is provided through lists of examples, which examples can be used in various combinations. In each instance, the recited list serves only as a representative group and should not be interpreted as an exclusive list.

### BRIEF DESCRIPTION OF THE DRAWINGS

The disclosure will be further described with reference to the drawings, wherein corresponding reference characters indicate corresponding parts throughout the several views, and wherein:

FIG. 1 illustrates a front perspective view of a wall hanger, according to one embodiment of the present disclosure;

FIG. 2 is a rear perspective view of the wall hanger of FIG. 1:

FIG. 3 is a side view of the wall hanger of FIG. 1:

FIG. 4 is an exploded, front perspective view of the wall hanger of FIGS. 1-3:

FIGS. 5A-5C illustrate the insertion of the wall hanger of FIGS. 1-4 into a wall:

FIG. 6 is a side view of the wall hanger of FIGS. 1-5 following insertion into a wall;

FIG. 7 illustrates a perspective view of a wall hanger assembly, according to another embodiment of the present disclosure:

FIG. 8 is a rear perspective view of the wall hanger of FIG. 7:

FIG. 9 is a side view of the wall hanger of FIG. 7-8;

FIG. 10 is an exploded, front perspective view of the wall hanger of FIGS. 7-9;

FIGS. 11A-11B illustrate the insertion of the wall hanger of FIGS. 7-10 into a wall;

FIG. 12 illustrates a perspective view of a wall hanger assembly, according to another embodiment of the present disclosure;

FIG. 13 is a rear perspective view of the wall hanger of FIG. 12:

FIG. 14 is a side view of the wall hanger of FIG. 12-13:

FIG. 15 is an exploded, front perspective view of the wall hanger of FIGS. 7-9;

FIG. 16 illustrates a perspective view of a wall hanger assembly, according to another embodiment of the present disclosure:

FIG. 17 is a rear perspective view of the wall hanger of FIG. 16;

FIG. 18 is a side view of the wall hanger of FIG. 16-17;

FIG. 19 is an exploded, front perspective view of the wall hanger of FIGS. 16-18;

FIG. 20 illustrates a perspective view of a wall hanger assembly, according to another embodiment of the present disclosure:

FIG. 21 is a rear perspective view of the wall hanger of FIG. 20;

FIG. 22 is a side view of the wall hanger of FIG. 20-21;

FIG. 23 is an exploded, front perspective view of the wall hanger of FIGS. 20-22; and

FIG. 24 illustrates a perspective view of a wall hanger assembly, according to another embodiment of the present disclosure;

While the above-identified figures set forth several embodiments of the disclosure other embodiments are also contemplated, as noted in the description. In all cases, this disclosure presents the invention by way of representation and not limitation. It should be understood that numerous other modifications and embodiments can be devised by those skilled in the art, which fall within the scope and spirit of the principles of the invention.

### DETAILED DESCRIPTION OF ILLUSTRATIVE EMBODIMENTS

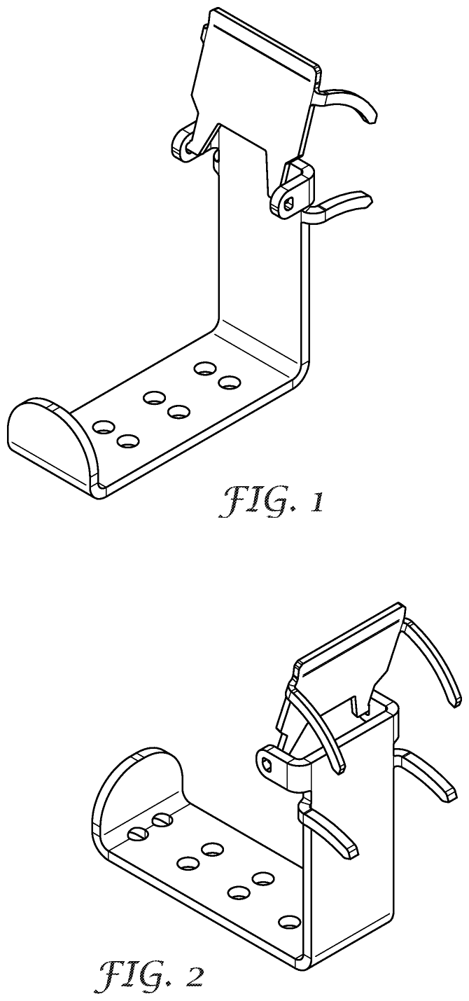

An installable wall hanger 100 according to the present disclosure is depicted in FIGS. 1-6. The hanger 100 includes two pivotably coupled plates that can cooperate in the mounting of relatively heavier weight objects. The wall hanger 100 includes a base plate 110 and a rotatable insert plate 130 pivotally coupled to the base plate 110 at hinge segments 109 adjacent the top edge 113 of the base plate 110. The base plate includes a front surface 111, a back surface 112, a bottom edge 114, and side edges 115, 116. Both the front 111 and back surfaces 112 are substantially planar, with the front surface 111 residing in a frame plane “P”. The base plate 110 and insert plate 130 have an overall, generally rectangular shape when viewed in a plane perpendicular to the base plate plane “P”. In other embodiments, the plates 110, 130 present another shape or combination of shapes in the same viewing direction, including circular, ovular, triangular tetrahedral. Y-shaped, etc. The shapes may be the same or different. Other variations are contemplated and discernable by those of skill in the art.

A pair of downwardly curved prongs 150 extend from each side edge 115, 116 (see FIG. 3) in direction generally orthogonal to the back surface 112 of the base plate 110. The prongs 150 extend to an outer end 152 that can be tapered to ease insertion when pressed into wallboard or other penetrable surface. A load bearing hook 170 extends outward in a direction away from the bottom edge 114. A pair of hinge guides 105 defining apertures 106 extend outwardly from the front surface 111 adjacent the top edge 113.

The lengths of one or both of the prongs 150 can be varied to allow selection for a specific thickness of wallboard. The curved prong 150 can have a fixed radius of curvature, or have varying radii of curvature at various points, either discretely or continuous, along the outer profile of the prong 150 from the base 151 to the outer end 152. The curvature produces a tip distance from the top edge 151a of the prong base 151 to a plane parallel to the outer end 152, with greater curvature producing a greater tip distance. While not wishing to be bound by theory or relation solely to gypsum wallboard, it is believed that an increase in tip distance leads to an increase in the weight that may be mounted on the hanger 100. In one exemplary embodiment, the tip distance is about 0.5 inches. In depicted implementations, the prongs 150 are downwardly curved, in that the end 152 is closer than the bottom edge at the base to a plane including the bottom edge 114 of the base plate 110. In other circumstances, one or more prongs may include an upward curve, in that the end 152 is closer than the top edge at the base to a plane including the top edge 113 of the base plate 110.

The prongs 150 may include one or more flat surfaces and may comprise different cross-sectional shapes and combination of shapes (e.g., rectangular, circular, ovular, triangular etc.). For instance, an upper surface of a prong may be rounded, with a planar bottom surface to prevent crack propagation in the wallboard. The flat surface can also aid in the prevention of pullout due to stress concentrations on the wallboard. In the embodiment depicted in FIGS. 1-6, each prong 150 includes opposing, substantially planar side surfaces 156, each side surface extending in a plane generally orthogonal to the base plane “P”. In other implementations, one or both edges 158 of the prong may be serrated.

Each of the prongs 150 include a height and a thickness at the base 151. The thickness is measured in a direction parallel to the top edge 113 (e.g., the x-direction) and corresponds to the distance between prong side surfaces 156. A comparison of height to thickness defines a prong aspect ratio. In presently preferred implementations, the aspect ratio is at least 1.5:1, at least 2:1; at least 3:1. In one exemplary embodiment, the height 155 can be about 0.10 inches and the thickness can be about 0.022 inches, resulting in a prong aspect ratio of 4.55:1. In other exemplary embodiments, the height 155 can be about 100 mils, and the thickness can be about 50 mils, resulting in an aspect ratio closer to 2:1. Typically the prong aspect ratio is no greater than about 5:1, and in other embodiments no greater than about 4:1. As further described below, the relatively thin nature of the prongs 150 reduces the needed insertion force, while the wallboard itself serves to prevent the buckling of the prong 150 as it is inserted. Relying on the wall to prevent buckling allows for the hanger to hold progressively heavier objects. The curved prongs 150 can taper in height over all or a portion of the arc length from base 151 to end 152 or can have a generally uniform height over the length as depicted.

Without wishing to be bound by theory, the prong aspect ratio can change the failure mode of the hanger by enhancing the strength of the prong in load-bearing directions (e.g., towards the bottom edge 114). The enhanced strength acts against the bending on the prong while the mounting of progressively heavier objects, such bending otherwise potentially resulting in the destruction of the wallboard before the prong yields. A relatively high aspect ratio prong can accordingly perform to user expectations for more typical mounting hardware (e.g., nails, screws, etc.) while still reducing the work needed to install.

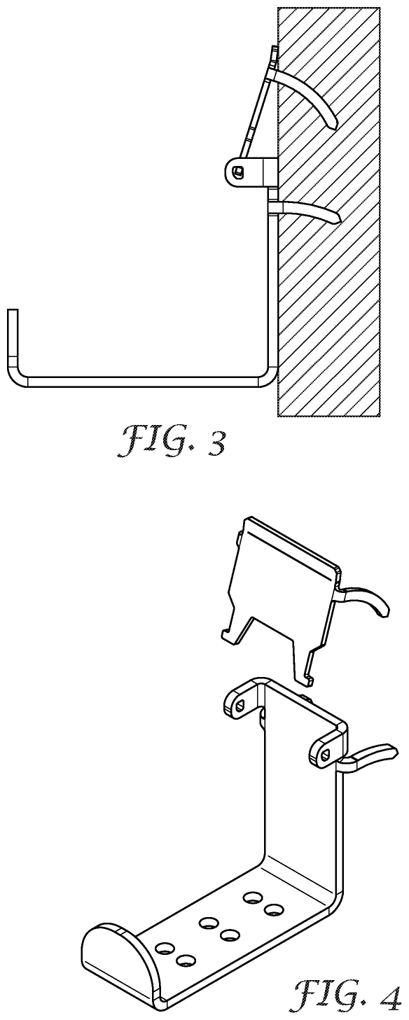

In the illustrated embodiment, and as can be seen particularly clearly from FIGS. 1 and 2, the prongs 150 can be formed from a monolithic piece of material that has been bent or otherwise articulated at select locations to form both base plate section 110 and prongs 150. Thus, each of the prongs 150 includes at least one section that is integral and substantially coplanar with a side edge 115, 116 of the base plate 110. In other embodiments, one or more of the prongs may be soldered, welded, or otherwise attached to the back surface 112 of the base plate 110 at an edge 115, 116 or other location spaced from the hook 170. Any of the prongs 150 may be previously articulated when provided to a user, or the user may opt to bend each of the wall-penetrating components to the user's liking.

As depicted, both the prongs 150 extend to coplanar endpoints and prongs 150 each include the same radius of curvature. In alternative embodiments, either of the prongs 150 may be offset from the other along the length of the respective edge 115, 116, such that one prong base 151 is nearer to the top edge 113 than the other. Furthermore, the base plate 110 may include one or more prongs in addition to the depicted pair of prongs 150; such additional prong(s) may feature the same or different radius of curvature, prong aspect ratio, outer end plane, length, or position relative to edges 113, 114, 115, 116 or back surface 112 of the base plate 110. The additional prongs may increase the weight hanging capabilities of the hanger but may result in additional damage to a wall surface on installation and greater insertion force. Moreover, the plurality of insertion points provided by multiple prongs can improve the stability of a hanger during installation, use, and removal.

The insert plate 130 includes a front surface 131, a back surface 132, a top edge 133, and a bottom edge 134. A pair of legs 137 extend outwardly from the side edges 135, 136 adjacent bottom edge 134, terminating in a pair of hinge axles 138. The hinge axles 138 are received in apertures 106 in hinge guides 105 to form a hinge segment 109 and pivotally couple the inert plate 130 to the base plate 110. The hinge segment 109 allows the base plate 110 and insert plate 130 to pivot relative to one another along a hinge axis “A”.

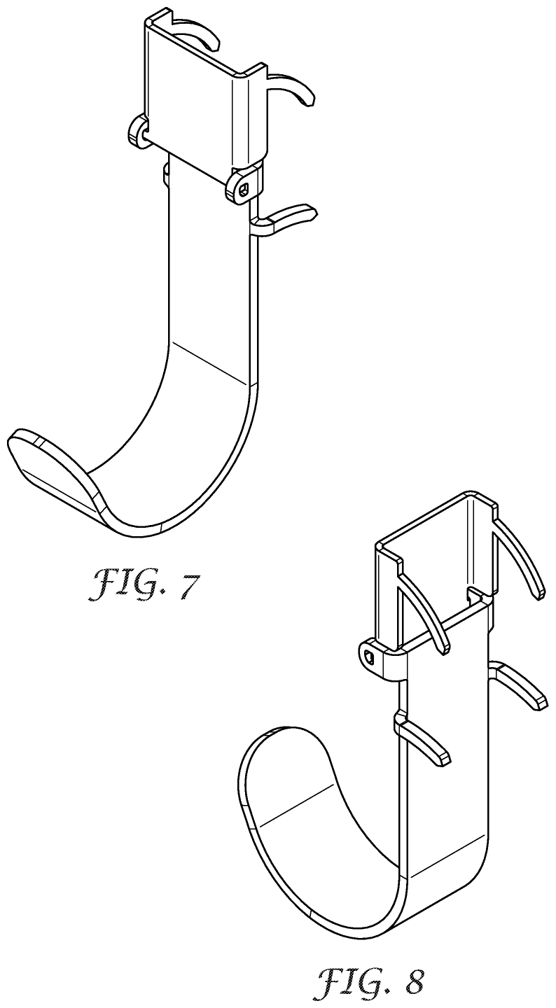

The hinge guides 105 position the guide apertures 106 a height “H”, as measured to the center of the aperture 106, above the back surface 112 that is typically flush with the vertical surface upon installation. The height “H” is designed such that hinge axis A is offset from the top edge 113 of the base plate 110. For reasons examined in more depth below, a hinge axis A offset from the wall may tend to inhibit undesirable rotation of the base plate when an item is providing a load on the hook 170 and provide aid to the user in install insert plate 130 into a penetrable surface. In other embodiments (e.g., FIGS. 8 & 9), the hinge axis A may be located near or further from the base plate 110.

The hinge guide 105 and apertures 106 may include geometry or other structures designed to limit the rotation of the insert plate away from the wall, such as a U-shaped, triangular, trapezoidal or other shape with linear stop surfaces. In alternative embodiments, the insert plate 130 may be coupled to the base plate 110 by one or more hinge pins, living hinges, or like structures to provide pivotal movement. Such alternative hinge arrangements may also include geometry designed to limit the rotation of the insert plate away from the wall, such as a triangular, trapezoidal or other shape with linear stop surfaces.

The insert plate 130 also includes a pair of curved prongs 160, each extending from one of the side edges 135, 136 adjacent to the distal, top edge 133. The considerations and features related prongs 150 discussed above are equally relevant to prongs 160 and need not be repeated. Prongs 160 tend to extend along an arc having a greater length than prongs 150 and can have a taller height at the base 161. The hinge axis A can be spaced from the prong base 161 such that the hinge axis A is located at the radial center of an arc defined by the curvature of the prong 160. Such spacing may, in certain embodiments, help in ensuring that the prongs 160 are inserted along an appropriate curved path.

As depicted, both the prongs 160 extend to coplanar endpoints and prongs 160 each include the same radius of curvature. In alternative embodiments, either of the prongs 160 may be offset from the other along the length of the respective edge 135, 136, such that one prong base 161 is nearer to the top edge 133 of the insert plate than the other. Furthermore, the insert plate 130 may include one or more prongs in addition to the depicted pair of prongs 160: such additional prong(s) may feature the same or different radius of curvature, prong aspect ratio, outer end plane, length, or position alongside a side edge 135, 136 or back surface 132 of the insert plate 130. The additional prongs may increase the weight hanging capabilities of the hanger but may result in additional damage to a wall surface on installation. Moreover, the plurality of insertion points provided by multiple prongs can improve the stability of an hanger during installation, use, and removal.

The load bearing hook 170 extends outward from the front surface 111 of the base plate 110 at bottom edge 114. The hook 170 includes a hook ledge 172 that extends in the Z-direction generally perpendicular to the base plate plane P. The ledge 172 terminates in a lip 174, projecting substantially parallel to the base plate plane P. The load bearing structures used on the plate 110 may instead include a button, a curved hook, an angled hook, a shank, or any number of load bearing structures used to hang articles. Furthermore, a hanger 100 may include three or more load bearing structures aligned along a longitudinal axis, a latitudinal axis, or both. It should be appreciated that the load bearing hook 170 may be placed at any desired location on the front face 111, though such placements may reduce the shear holding capacity of the hanger and limit the type of objects that may be mounted thereon.

Like the prongs 150, 160 the first and second load bearing hook 170 can be formed from a monolithic piece of material that has been bent or otherwise articulated at select locations to form both base plate 110 and the hook 170. The hook 170 can be created, for example, by cutting (e.g., die stamping, laser cutting, etc.) a portion of the base plate 110 along a path to form a hook outline, which can then be bent outwardly from the bottom surface 113 to form the respective projection.

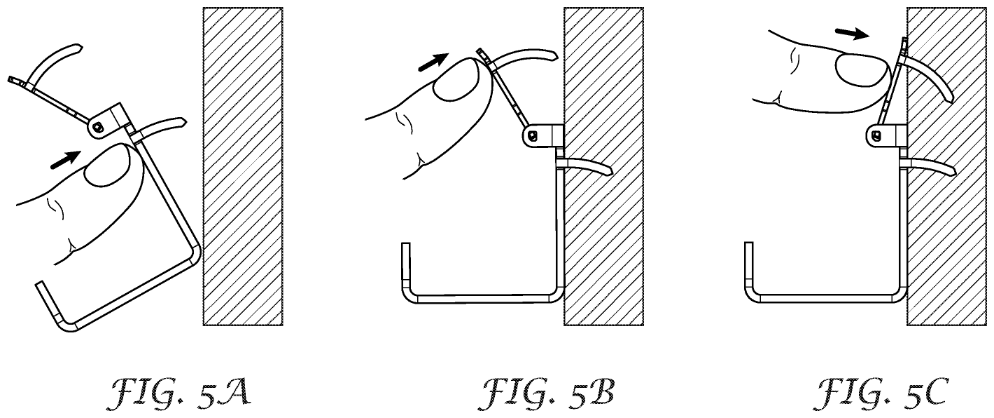

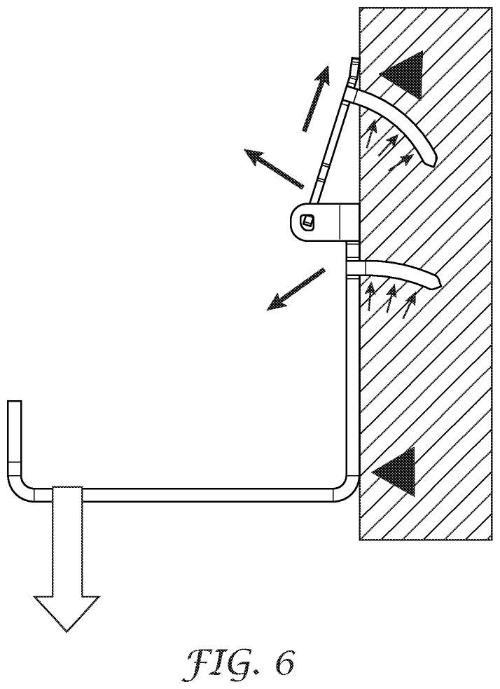

Referring to FIG. 5A-5C, one method for attaching the wall hanger 100 to a substantially vertical surface 10 may include multiple steps to properly secure the hanger. In a first step, a user places the base plate 110 at the desired location on the vertical surface 10 including wallboard 11. Once the user is satisfied with the location of the base plate 110, force can be applied in direction orthogonal to the front face 111, preferably at a location on the front face 111 adjacent each of the curved prongs 150. The hanger 100 is rotated about the bottom edge 114 so that the outer end 152 of each curved prong 150 extends horizontally toward the wall, with the outer point 152 at a desired entry point (FIG. 5A). The orthogonal force applied results in the hanger 100 rotating about the bottom edge 114 and the outer end 152 of the prongs 150 penetrating the wallboard 11. Further rotation results in the remaining length of the prongs 150 being driven into the wallboard 11 until the back surface 112 of the base plate 110 is generally flush with the vertical surface 10. Once the user is satisfied with this location of the base plate 110, force is applied in direction orthogonal to the front face 131 of the insert plate 130 near the top edge 133 (FIG. 5B). The force applied results in the hanger rotating about the hinge segment 109 and the outer end 162 of the prongs 160 penetrating the wallboard 11. Further rotation results in the remaining length of the prongs 160 being driven into the wallboard until the top edge 133 of the insert plate 130 is generally flush with the wall surface. Once installed, hinge guides 105, insert plate 130, and vertical surface 10 form a recess 190 having a generally triangular cross-sectional shape (FIG. 5C).

As shown in FIG. 6, an object may be secured on either load bearing hook 170 before or after the hanger 100 has been inserted into the wall. Once an object is left to hang on hook 170 it has a weight “W” that creates a force moment “L_{R1}” in the rotational direction away from the wall and downward as the base plate 110 seeks to pivot about the bottom edge 114. This translates to the force that provides a bias or urging outward of the curved prong 150. The smaller the distance between the curved prong 150 and the pivot point, the greater the force urging the hanger out of the wall. As this occurs, the insert plate 130 tends to rotate in the opposite direction (“L_{R2}”) as it pivots about hinge axis A. This tends to induce a tensile reaction force (R₁) within the insert plate 130 that restrains the rotation of the base plate 110. As this happens, insert prongs 160 tend to drive deeper into the wallboard. Accordingly, the hanger 100 is less likely to dislodge from the wall or cause considerable damage to the wallboard. Locating the hinge axis A spaced from the wall surface 10 allows for a greater arc length on prongs 160, providing greater penetration in wallboard 11 and more secure anchoring of hanger 100.

In presently preferred implementations of the present disclosure, the hanger is made of a metal containing material, however, it can be appreciated that other suitable materials can be used. The hanger 100 is typically made from a resilient metal or metal alloy, such as stainless steel, titanium, cobalt-chromium alloy, or a shape-memory alloy such as an alloy of nickel and titanium (e.g., Nitinol). Preferably, the hanger 100 is sufficiently resilient so that the shape when relaxed does not significantly change during the course of mounting an object. As another option, the hanger 100 could be made from any other resilient material known to one skilled in the art, such as a flexible polymer or composite material. Moreover, although the hanger 100 is specifically discussed as mountable on a wall of gypsum wallboard, it can be utilized with walls of other materials or to secure an object to something other than a wall.

The wall hanger 100 may be used alone or in multiples to hang backpacks, book bags, household tools, gardening tools, hoses, buckets, linens, coats, bicycles, shelves, and curtain rods. In some embodiments, a plank (e.g., relatively planar length of wood or other material) may be registered on the ledge 172 of two or more hangers 100 to create a shelf. In the same or other embodiments, the plank may include apertures for receipt of lip 174, creating the appearance of a floating shelf.

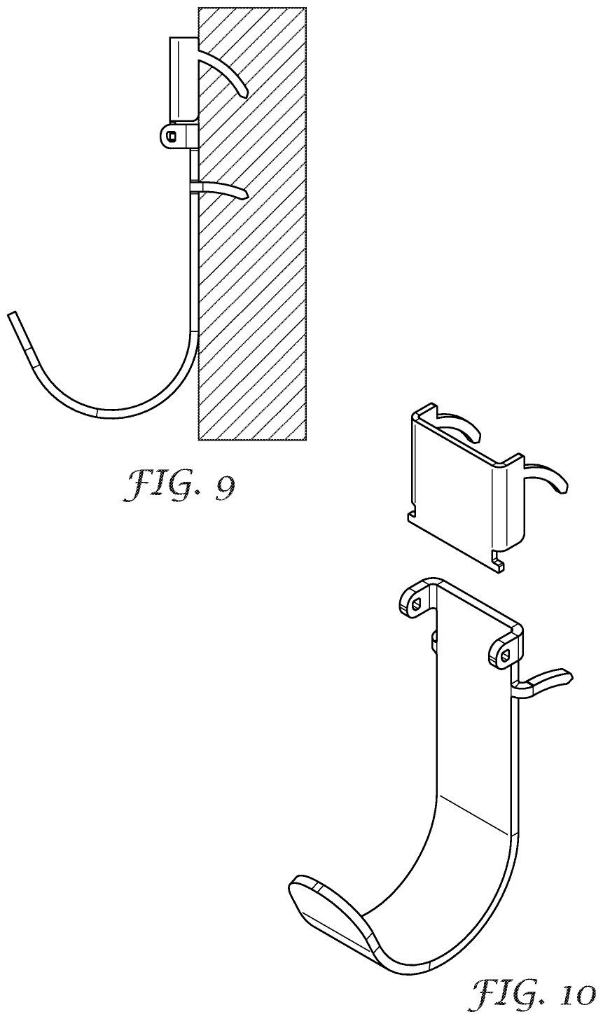

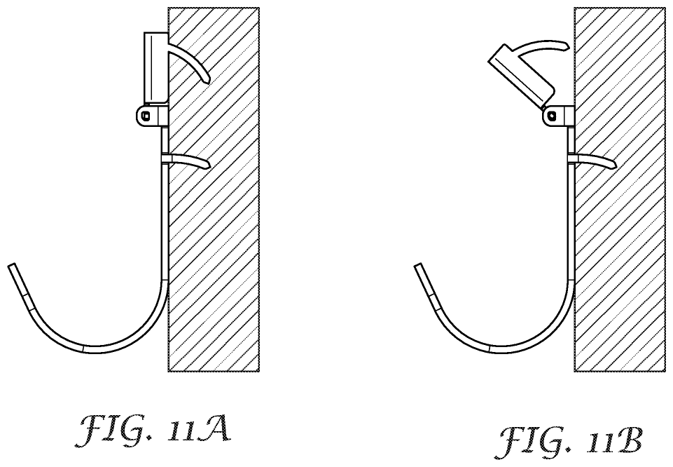

Turning to FIGS. 7-10, another embodiment of a wall hanger 200 according to the present disclosure is depicted. The hanger 200 includes two pivotably coupled plates that can cooperate in the mounting of relatively heavier weight object. The wall hanger 200 includes a base plate 210 and an insert plate 230 pivotally coupled to the base plate 210 at hinge segments 209 adjacent the top edge 213 of the base plate 210. Both the front 211 and back surfaces 212 are substantially planar, with the front surface 211 residing in a frame plane “P”. The hook 270 includes a curved load bearing surface 272. It is to be understood that many other aspects of hanger 200 may have similar form and function to those described with respect to hanger 100 and these need not be repeated.

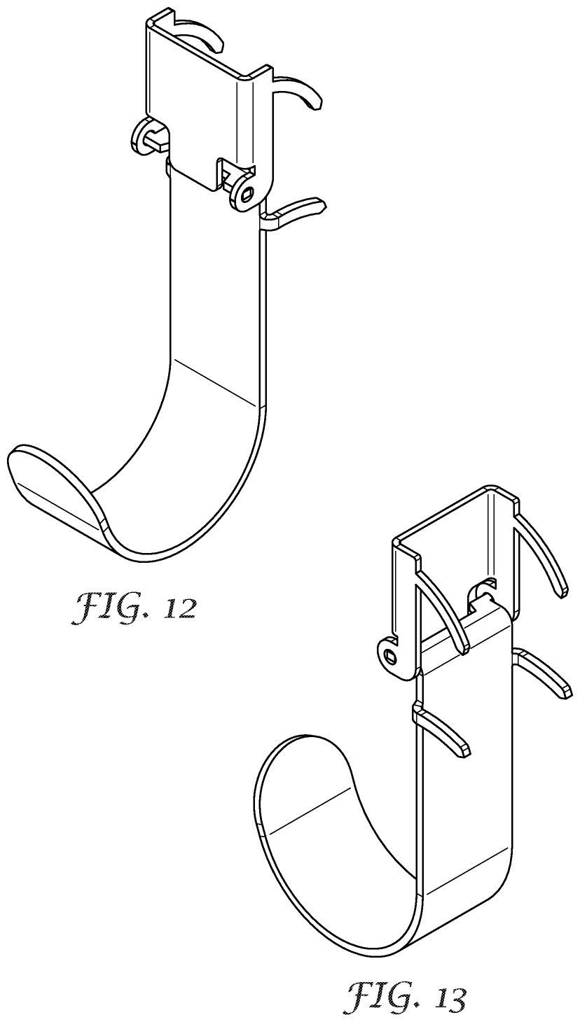

Unlike prongs 160, prongs 260 do not project directly from the side 235, 236 or rear 232 surfaces of the insert plate 230. Insert plate 230 includes wings 240 projecting rearwardly from each side 235, 236. The wings 240 extend the length of each side edge 235, 236 as depicted, however, the wings 240 may extend any portion of the side edge length in other embodiments, including a portion primarily adjacent the top edge 233. The wings 240 have a height 242 substantially similar to the height “H” of guide apertures 206. The correspondence in height allows the rear edge 243 of the wing 240 to rest substantially parallel to a vertical surface when the prong(s) 260 are fully inserted (see FIG. 11B). With the rear edge flush with the vertical surface, the front 231 of the insert plate 230 and front surface 211 of the base plate 210 reside in substantially parallel planes but are not necessarily coplanar.

The wing 240 tends to enhance the feedback and ergonomics during installation for the user, as the wings create a tactile register to the install surface once the prong 260 is fully inserted (See FIG. 11A).

Another embodiment of the present disclosure and variation of wall hanger 200 is depicted as wall hanger 300 in FIGS. 12-15. The wall hanger 300 includes a base plate 310 and an insert plate 330 pivotally coupled to the base plate 310 at hinge segments 309 adjacent the top edge 313 of the base plate 310. The insert plate 330 includes hinge guides 337 adjacent a flap 339 along the bottom edge 334: this represents an opposite pairing to hanger 100, 200, which feature hinge guides on the base plate and not the insert plate. It is to be understood that many other aspects of hanger 300 may have similar form and function to those described with respect to hanger 200 and these need not be repeated.

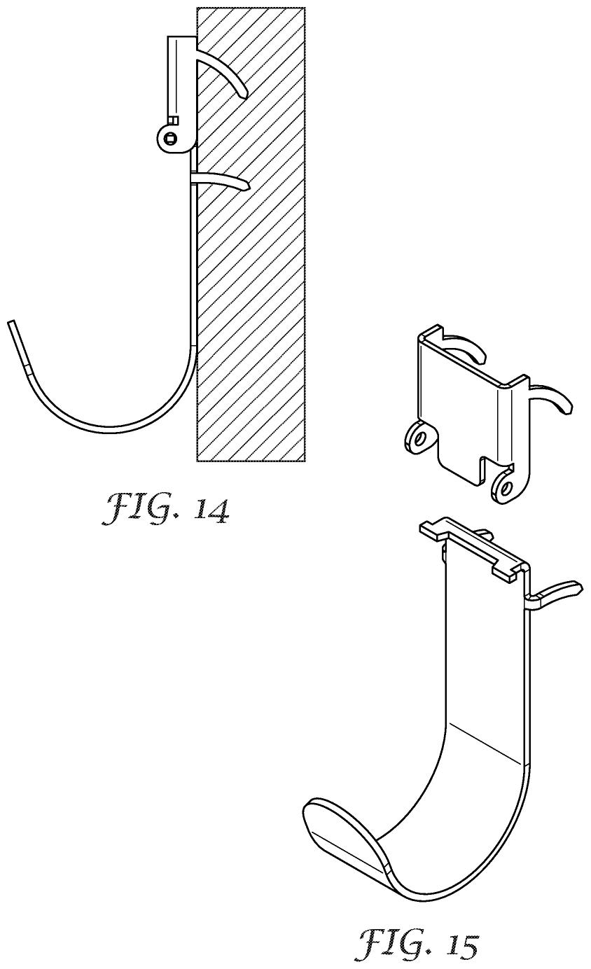

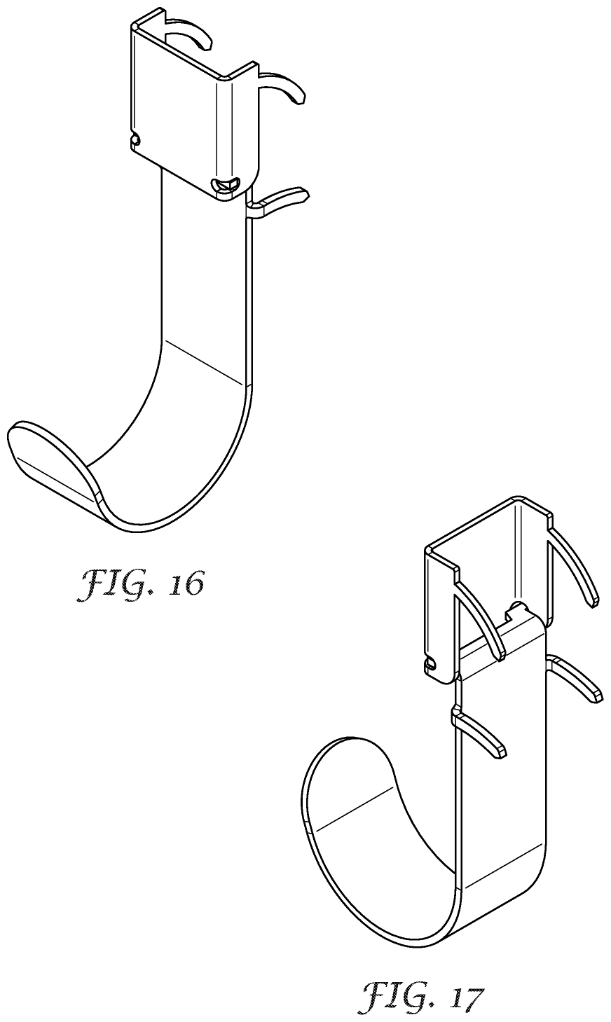

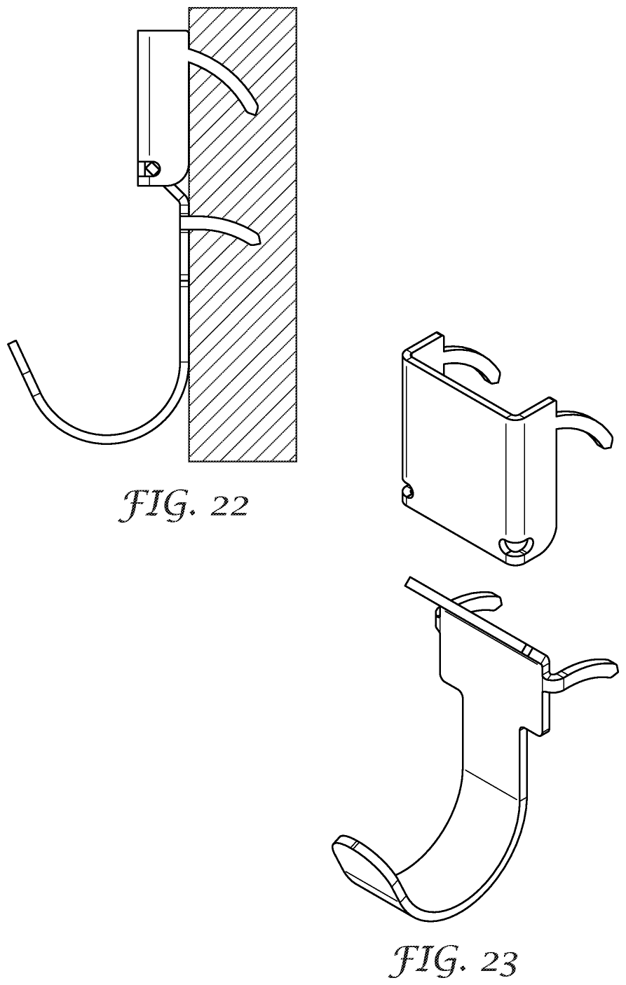

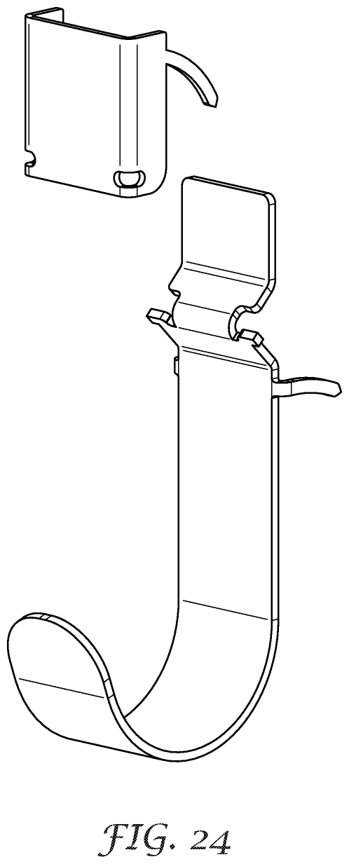

The base plate 310 includes a ledge 320 projecting substantially orthogonal to the hanger plane “P”. In other embodiments, such as the hanger 500 depicted in FIGS. 20-23, the ledge 320 may project at other oblique angles relative to front surface 311 and base plane P. In other embodiments, such as FIG. 24, the ledge 320 may not reside at the top edge of the base plate. The ledge 320 features one or more hinge axles 322 protruding in opposite directions from the sides thereof and a gap 323 between axles 322 (see FIG. 15). The hinge axels 322 are generally rectangular in cross-section and terminate at a plane near or coplanar with the prong base 351. The hinge axles 322 may incorporate other cross-sectional shapes as desired.

The insert plate 330 of wall hanger 300 includes a pair of hinge guides 337 adjacent bottom edge 334. The hinge guides 337 include bearing apertures 338 for receipt of hinge axles 322 in order to form the hinge segment 309. The hinge guides 337 are integral with wings 340 and project in a direction opposite prongs 360 and bottom edge 334. The hinge guides 337 are further spaced from the side edges of lower flap 339 to create a recess for easier receipt of hinge axles 322. The center of the bearing apertures 338 is generally coplanar with the base plane P. When assembled, the lower flap 339 tends to reside in the gap 323 between the hinge axles 322, whereby the ledge protects against excess rotation of the insert plate about the hinge axis. The arrangement of components in this manner allows insert plate 330 to be manufacturable from a single sheet of material, particularly allowing the user of relatively thinner starting materials.

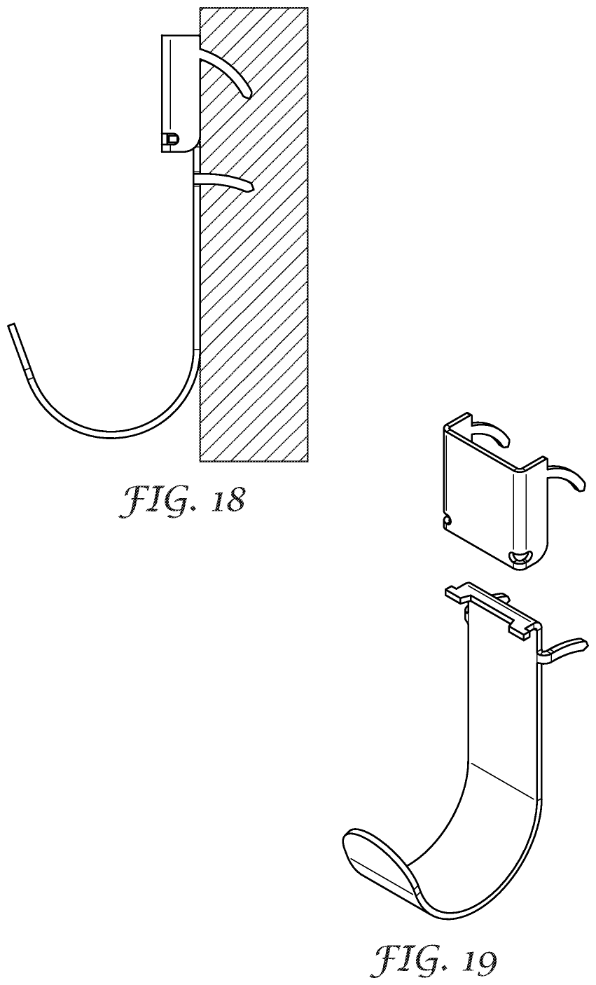

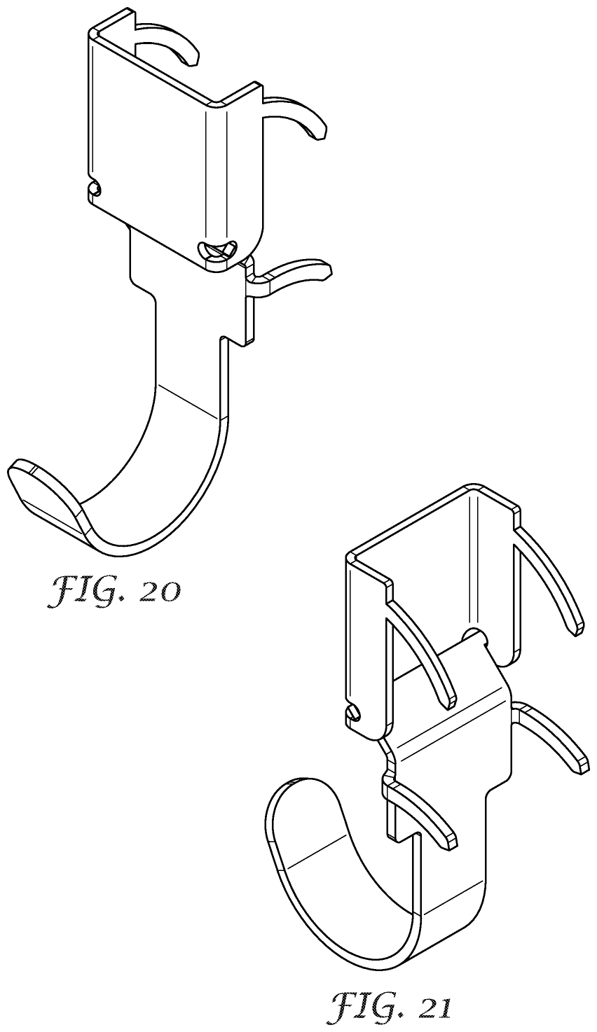

As depicted in FIGS. 16-19, another embodiment of an insert plate 430 includes hinge apertures 438 formed in both the insert plate body 431 and wing 440. The hinge guides 337 of insert plate 330 tend to project beyond the front surface 332 (see FIG. 14), which can introduce aesthetic concerns for some users. The hinge apertures 438 include an open, U-shaped configuration, with an arcuate bottom surface 438a and planar side surfaces 438b. The U-shaped configuration can aid in assembly of the insert plate 430 to the hinge axles 322 on the base plate, as well as aid rotation of the insert plate 430 about the hinge axis A.

Another variation on wall hangers of the present disclosure is depicted in FIGS. 20-23, which depict a wall hanger 500 including the insert plate 430 pivotally coupled to a base plate 510. The ledge 520, at the top edge 513 of the base plate 510, features one or more hinge axles 522 protruding in opposite directions from the sides thereof. The ledge 520 projects outward at an angle of about 135 degrees relative to the hanger plane “P”. The resultant orientation of the ledge 520 reduces the dimensional mismatch between the hinge aperture 438 and the axles 522, leading to enhanced stability when the wall hanger 500 is installed.

The wall hangers of the present disclosure may be used to mount myriad items and objects to surfaces such as painted drywall, plaster, concrete, glass, ceramic, fiberglass, metal or plastic. Items that can be mounted include, but are not limited to, wall hangings, heavy art, mirrors, organizers, holders, baskets, containers, bicycles, toys, lawn games, gardening tools, decorations (e.g., holiday decorations), dispensers, wire clips, guitars, floating shelves, plants, curtain rods, heavy-duty hooks, brackets, wall sconces, and carrying handles.

The patents, patent documents, and patent applications cited herein are incorporated by reference in their entirety as if each were individually incorporated by reference. It will be apparent to those of ordinary skill in the art that various changes and modifications may be made without deviating from the inventing concepts set from above. Thus, the scope of the present disclosure should not be limited to the structures described herein. Those having skill in the art will appreciate that many changes may be made to the details of the above-described embodiments and implementations without departing from the underlying principles thereof. Further, various modifications and alterations of the present invention will become apparent to those skilled in the art without departing from the spirit and scope of the invention. The scope of the present application should, therefore, be determined only by the following embodiments and equivalents thereof.

1. A wall hanger assembly comprising:
a base plate including one or more curved prongs each having a base, wherein each prong of the one or more prongs extends outwardly along an arc to a wall-penetrating outer end, and wherein the base of the prong is coincident with one of first and second opposing side edges of the base plate; and
a first insert plate pivotally coupled to the base plate and including a proximal edge, a distal edge, and opposing side edges, the insert plate further including
a first curved prong having a base, wherein the prong extends outwardly along an arc to a wall-penetrating outer end.

2. The wall hanger assembly of claim 1, wherein the one or more prongs includes a pair of curve prongs.

3. The wall hanger assembly of claim 2, wherein the pair of curved prongs each extend to an outer end, the outer ends are coplanar.

4. The wall hanger assembly of claim 1, wherein the base plate is pivotally coupled to the first insert plate at a first hinge segment.

5. The wall hanger assembly of claim 4, wherein the hinge segment includes a pair of hinge guides having apertures for receiving hinge axles.

6. The wall hanger assembly of claim 5, wherein the hinge guides are proximate a top edge of the base plate, and wherein the hinge axles are coupled to legs extending from the proximal edge of the first insert plate.

7. The wall hanger assembly of claim 5, wherein the base plate includes a ledge proximate the top edge, the ledge includes the hinge axles extending in opposite directions.

8. The wall hanger assembly of claim 7, wherein the ledge projects outward in a substantially orthogonal direction relative to the front surface of the base plate.

9. The wall hanger assembly of claim 7, wherein the ledge projects outward at an obtuse angle relative to the front surface of the base plate, as measured between an underside of the ledge and the front surface.

10. The wall hanger assembly of claim 7, wherein the ledge projects outward at an obtuse angle of about 135 degrees.

11. The wall hanger assembly of claim 5, wherein the hinge guides are disposed on the first insert plate.

12. The wall hanger assembly of claim 11, wherein the first insert plate includes a pair of wings projecting rearwardly from the front surface and extending along at least portions of the side edges, and wherein a base of the curved prong is coincident with an edge of a first wing of the pair of wings.

13. The wall hanger assembly of claim 12, wherein the hinge apertures are at least partially formed in the pair of wings.

14. The wall hanger assembly of claim 1, wherein the first insert plate is pivotable about a hinge axis.

15. The wall hanger assembly of claim 14, wherein the hinge axis is offset from the front surface of the base plate.

16. The wall hanger assembly of claim 1, wherein, when the wall hanger is installed on a vertical surface, the first insert plate is fixed at an acute angle relative to the vertical surface.

17. The wall hanger assembly of claim 1, wherein the base of the prong has a height measured along the side edge and a thickness measured along the top edge, and wherein the height is a least three times the thickness.

18. The wall hanger assembly of claim 1, wherein the first insert plate is rotatable in the direction away from the front surface of the base plate to insert the curved prong into a surface.

19. The wall hanger assembly of claim 1 wherein the first insert plate further includes a second curved prong extending outwardly along an arc to an outer end, and wherein the outer end of the first prong and the outer end of the second prong are coplanar.

20. The wall hanger assembly of claim 1, wherein the assembly is adjustable between an open state and a closed state, and wherein the first insert plate includes a rear surface residing in a plane substantially parallel to a front surface of the base plate in the closed state.
